(19) United States
(12) Patent Application Publication
(10) Pub. No.: US 2002/0081018 A1
(43) Pub. Date: Jun. 27, 2002

(54) Inspection method for master disk for magnetic recording media

(75) Inventors: Seiji Hamano, Nishinomiya-shi (JP); Hajime Kawano, Osaka (JP); Noriaki Yukawa, Osaka (JP); Tsuyoshi Nomura, Kyoto-shi (JP)

Correspondence Address: PARKHURST & WENDEL, L.L.P., Suite 210, 1421 Prince Street, Alexandria, VA, 22314-2805, US

(73) Assignee: MATSUSHITA ELECTRICINDUSTRIAL CO., LTD.

(21) Appl. No.: 10/026,970

(22) Filed: Dec. 27, 2001

(30) Foreign Application Priority Data
Dec. 27, 2000 (JP) 2000-397647

(51) Int. Cl. G06K 9/00

(52) U.S. Cl. 382/151

(57) ABSTRACT

It is an object of the present invention to enable a strict and efficient inspection for a defect in a geometric pattern of a ferromagnetic thin-film layer of a master disk for magnetic recording media used in a device such as an AVHDD, in which initial information is recorded. Alignment marks 16 are formed in a plurality of positions on a circumference concentric with the recording section simultaneously with forming recording bands 14 constituting the information recording section on the master disk 10, the image of the recording bands 14 and the marks 16 on the master disk 10 is obtained, the image of recording section and non-defective product information is aligned based on the image of the marks 16, and then the images of the recording bands 14 are compared with the non-defective information to inspect the geometry pattern of the information recording section.

### FIELD OF THE INVENTION

The present invention relates to an inspection method for a master disk for magnetic recording media, and in particular, to a method for inspecting a master disk from which initial information is copied to a high-density magnetic recording medium such as a digital television hard disk, commonly known as “AVHDD”, for defects in an information recording section in which the initial information is recorded.

The present invention also relates to a method for inspecting mask patterns used for manufacturing the master disk.

### BACKGROUND OF THE INVENTION

Like an HDD (Hard Disk Drive) for a typical personal computer, a magnetic recording disk is used for AVHDD. However, AVHDD is used with an AV (Audio/Video) system, therefore has an increased recording density and uses sophisticated recording schemes in order to provide the functions of reading/writing a large amount of sequential data, such as music and visual data, and recording multi-channel information.

Initial information is recorded on the AVHDD magnetic recording disk before use. The initial information includes a servo signal for tracking, address information signal, and playback clock signal. The magnetic recording disk containing this initial information is used for reading and writing information such as music and visuals. If the initial information is not correctly recorded, the accuracy of recording music and visuals cannot be improved, as a matter of course.

The initial information is recorded on a magnetic recording disk by placing a master disk over the magnetic recording disk to copy the initial information recorded on the master disk in advance as magnetic pattern to the magnetic recording disk.

As shown in FIG. 8, a ferromagnetic thin-film layer made of material such as cobalt is provided on the surface of a substrate 21 made of silicon and geometric patterns 22 on the ferromagnetic thin-film layer represent the initial information.

If the initial information is incorrectly recorded on the master disk, initial information on all the magnetic recording disks produced using the master disk, of course, will be also incorrect and all of them will be defective disks.

Therefore, whether the initial information on the master disk, that is, geometric patterns on the ferromagnetic thin-film layer, is correctly formed should be inspected strictly during the manufacturing process of the master disk.

Defects produced in the ferromagnetic thin-film layer of the master disk include soil in photo-mask during a thin-film formation process, delamination of the thin-film layer during lift off, contamination, flakes, and photo-resist bubbles.

These defects in the master disk can be detected by observing the surface of the master disk under a high-power microscope. However, it is considerably inefficient and prone to overlooking a defect to visually inspect all of the miniature ferromagnetic thin-film patterns provided all over the master disk.

Technologies for inspecting the surface of a silicon substrate are known, such as one described in Japanese Patent Laid-Open No. 62-43505. According to these technologies, a semiconductor chip 2 provided in grid form on the surface of a silicon substrate 1 is detected as a pattern to be inspected and compared with a predetermined pattern as shown in FIG. 9. An XY stage 3 is driven to detect the semiconductor chip.

However, it is difficult to efficiently and precisely inspect the above-mentioned geometric patterns 22 extending radially from the inner toward outer radius, rather than in grid form, by using these technologies, including the technology described in Japanese Patent Laid-Open No. 62-43505.

### DISCLOSURE OF THE INVENTION

It is an object of the present invention that enables a strict and efficient inspection for defects in a geometric pattern on a ferromagnetic thin-film layer for recording initial information on a master disk for magnetic recording media used in applications such as the above-mentioned AVHDD, etc.

According to the present invention, there is provided an inspection method for inspecting a geometric pattern of an information recording section consisting of a ferromagnetic thin-film layer formed on a master disk from which initial information is copied to a magnetic recording medium, the method comprising: (a) forming alignment marks in a plurality of positions on a circumference concentric with the recording section simultaneously with forming the information recording section on the master disk; (b) providing non-defective product information representing a non-defective geometric pattern of the information recording section; (c) capturing the image of the information recording section of the master disk and the image of the marks; and (d) aligning the image of the information recording section with the non-defective product information with respect to the image of the marks, then comparing the image of the information recording section with the non-defective product information to inspect the information the geometric pattern of the information recording section.

[Master Disk]

The material of the disk and ferromagnetic thin-film layer and their forming method, and the initial information recorded in the information recording section are not limited, provided that the initial information to be copied to a magnetic recording medium is provided the information recording section consisting of a ferromagnetic thin-film layer.

The material of a substrate serving as the main body of the master disk may be a semiconductor material such as silicon, ceramic, glass, or synthetic resin. The shape of the substrate may be a disc, like a compact disk, that has a through hole in its center, or a disc without any through hole in its center.

The ferromagnetic thin-film layer can be formed on the surface of the substrate in patterns of a ferromagnetic metal such as cobalt or a ferromagnetic alloy by using a thin-film deposition technology such as spattering and photolithography. The ferromagnetic thin-film layer may project from the surface of the disk or embedded in the disk so as to be flush with the surface of the disk.

[Initial Information]

The initial information recorded on the information recording section may include any information that is needed to be pre-recorded for using the magnetic recording disk.

In particular, it includes signals such as a tracking servo signal, address information signal, and playback clock signal.

The initial information does not include information such as music that is overwritten in the use of the magnetic recording disk.

[Information Recording Section]

Any specific geometries and layout patterns of the ferromagnetic thin-film layers of the information recording section can be chosen, provided that the geometries and layout patterns represent desired initial information. For example, a number of ferromagnetic thin-film layer in thin-line form can be arranged to represent information by the thickness of the lines and a space between lines. A number of strip regions, that is, recording bands consisting of a set of thin-line patterns of such ferromagnetic thin-film layers and extending in the direction of the radius of the disk can be arranged along the circumference of the disk. The recording band may be extend linearly in the direction of the radius of the disk or in a smooth curve suitable for a read operation.

If the information recording section consists of a set of recording bands, different information is recorded in the individual recording bands. The initial information is recorded sequentially in the bands in the direction of the circumference of the disk, starting from a certain one of the recording bands. The position from which the initial information recording is started may be called the starting point of the information recording section.

While the information recording section may be provided from near the center to near the edge of the disk, typically the information recording section is not formed within a certain range from the center and within a certain range from the edge of the disk.

[Alignment Mark]

Alignment marks indicate the position and attitude of a recording section. The can also indicate the center of the information recording section. The starting position, that is, the origin of the initial information recording in the direction of the circumference of the information recording section.

The marks are formed simultaneously with the information recording section, that is, ferromagnetic thin-film layers. The term “simultaneously” herein means that they undergo a process such as thin-film deposition or etching by using the same mask pattern or undergo laser processing in the same process. By simultaneously forming the marks and the information recording section, a processing error and difference in geometry precision between the marks and information recording section can be avoided, thus enabling the marks to accurately indicate the position and altitude of the information recording section.

The shape, position, and number of the marks can be changed according to the purpose of alignment. The marks may be any graphics, symbols, or letters.

By forming the marks in a plurality of positions on a circumference concentric with the information recording section, the center of the plurality of the marks can indicate the center of the center of the information recording section.

The mark may be provided at a position indicating the above-mentioned starting point of the information recording section. Alternatively, one of the above-mentioned marks provided in the plurality of positions on the circumference may indicate the starting point.

The marks can be provided in any positions on the surface of the master disk where the information recording section is not formed. They can be positioned in a region between the center of the disk and the information recording section or a region the information recording section and the outer edge of the disk.

[Inspection of Master Disk]

Geometric patterns in the information recording section consisting of ferromagnetic thin-film layers formed on the master disk are inspected.

Non-defect product information representing a correct geometric pattern of the information recording section is used as inspection reference information. The non-defect product information is compared with a product image, which is a captured image of a master disk product to inspect the geographic patterns in the information recording sections formed on the product for any defect, or determine whether the master disk is an acceptable or defective product.

[Non-Defective Product Information]

Non-defective product information indicates the geometric pattern of a non-defective product in the information recording section.

The non-defective product information may be a captured image of a master disk judged as being non-defective among master disks manufactured, that is, a non-defective product image or its electronic data.

The non-defective master disk can be selected by inspecting master disks by using an inspection method other than a method according to the present invention. In particular, a non-defective product can be selected by magnifying the surface of master disks is magnified under an optical microscope and visually inspected. Operation tests, such read and write tests are conducted on a magnetic recording disk to which initial information is copied from the master disk. If it is determined that the magnetic recording disk operates successfully, the master disk used for creating the initial information on the magnetic recording disk can be determined as being non-defective. In addition, the image of the master disk product determined as non-defective by using the inspection method according to the present invention may also be used as non-defective product information in the subsequent inspections.

[Design Data]

The non-defective product information can be generated from design data for forming an information section on a master disk.

The design data may be a design drawing, document, or CAD data. The image of a design drawing as is may be used as the non-defective product information. A computer program in which mathematical and conditional expressions for determining the geometries and layout patterns of the ferromagnetic thin-film layers specified in a document are written can be used for non-defective product information. CAD data is a electronic design drawing and suitable for processed by computer, etc.

[Image Capturing]

Commonly used image capturing means can be used to capture the images of recording section and marks on a master disk. The image capturing means should be an image capturing apparatus having adequate resolution to resolve the line-width of the ferromagnetic thin-film layers constituting the information recording section.

In particular, optical means such as an optical microscope combined with photoelectric conversion means such as an electronic camera or CCD device obtains image information as an electronic image signal.

The image information used in inspection may include information about three-dimensional profiles and color tone of the ferromagnetic thin-film layers. It should include at least information required for identifying the presence and shape of a defect in the ferromagnetic thin-film layers. For example, it may include only binary information required for determining whether a ferromagnetic thin-film exists in each spot within an image.

An image area that can be captured by the image pickup lens of the image capturing means at a time is limited. Therefore, the pickup lens and the master disk are moved with respect to each other and the entire information recording section is scanned by the pickup lens to capture the image of the entire information recording section of a master disk.

For doing so, the master disk can be held on a rotatable inspection stage or the image pickup lens can be provided so as to be capable of moving in the direction of the radius of the master disk. The movement of the inspection stage and the pickup lens can be detected and controlled by computer and positional information thus obtained can be added to a captured partial image and used for constructing the image of the entire information recording section.

The captured image is provided through components such as an image processor, converted into electronic data suitable for inspection operation, then sent to a computer which performs the actual inspection operation.

[Comparison Inspection]

The image of a master disk product is electronically compared with non-defective product information by computer to inspect the information recording section of the master disk for any difference from the non-defective product information.

The center of the product image or the starting position of initial information recorded in the information recording section is found based on the marks.

The center or the starting position in the product image is aligned with that in the non-defective product information and then data in each position or region in the product image is compared with data in corresponding position or region in the non-defective product information.

If any difference is found, then there is a defect in the information recording section of the master disk and therefore the master disk is judged as being defective.

The defective/non-defective judgment at a practical level can be made by adjusting the sensitivity of determination whether there is a difference between the non-defective product information and the product image. The sensitivity can be adjusted so that any difference that causes no problem for the use of the master disk is ignored.

[Correction of Design Data]

In some cases, geometry patterns of the information recording section of a master disk manufactured based on design data may not exactly match non-defective product information derived from the design data.

For example, it is often the case that an information recording section does not exactly match its design data because of restrictions on material and processing method used, an error during manufacturing, or a difference in shapes. Such an error and difference in manufacturing is allowed for in advance and does not affect the performance of the master disk in use.

However, strictly comparing non-defective product information derived from design data with the information recording section of a manufactured disk, a slight difference in geometry may be detected. As a result, a non-defective master may be judged as being defective.

To avoid the erroneous judgment due to such a difference between design data and a product, it is effective that the design data is corrected when non-defective product information is derived from the design data. The correction can be made to electronic image information.

The difference between design data and the product arises in the boundary between the outline of individual ferromagnetic thin-film layers and their surrounding substrate. Therefore, it is effective for design data to correct a portion along the outline of the ferromagnetic thin-film layers.

[Dead Zone]

The correction of design data may be the addition of a dead zone to the outline of geometric patterns, that is, ferromagnetic thin-film layers, in the information recording section. A width or position of the dead zone is chosen so that the a difference in geometry between design data and a product is included in the dead zone.

If comparison of a product image and non-defective product information is not performed in the dead zone during inspection, an error due to the difference between the design data and the product geometry does not arise. Precise comparison can be performed in regions other than the dead zone to detect even an inappreciable defect without fail.

[Division Inspection]

The comparison between non-defective product information and a product image may be performed after the non-defective information and product image data on the entire information recording section of a master disk are created. However, the amount of data on the entire information recording section may become huge.

The following method is effective for reducing the amount of data to be processed.

The image of the information recording section, that is, the product image, is aligned with non-defective product information based on the image of the marks as described above.

The image of the information recording section is divided to provide divided product images. If the amount of data on a division image is small, the subsequent process can be performed quickly but the number of repetitions of the process increases. These factors are traded off against each other to determine the amount of division image data or the area of an image to be processed at a time.

Non-defective product information on a corresponding portion is generated each time a division image is obtained.

If the non-defective product information is the image of a non-defective product, only a non-defective product image of a portion corresponding to the division image among non-defective product images stored in a storage such as an external storage device of a computer is provided to a comparison processor in the computer. If data conversion is required for a comparison operation, the non-defective image corresponding to the division image is converted.

If the non-defective information is generated from design data such as CAD, only design data on a portion corresponding to the division image among design data stored in a storage such as an external storage device of a computer is provided to a comparison processor in the computer and converted into data comparable with the product image. If the design data is to be corrected, the correction is performed at this stage.

The non-defective product image obtained in this way is compared with the division image to determine whether there is any defect in the product or whether the product is defective.

Once the inspection of one division image is completed, another division image of the product image is obtained. The non-defective product information used in the previous inspection is discarded and new partial non-defective product information corresponding to the new division image is generated. Thus, the amount of data handled in the computer is always only the amount of information on one division image and its corresponding non-defective product information.

The above-described process can be repeated to inspect the entire information recording section of the master disk.

[Application]

The inspection method according to the present invention can be applied to any magnetic-recording-medium master disks in various applications from which initial information is copied to magnetic recording media.

For example, it can be applied to a master disk for magnetic recording media used in an AVHDD. The AVHDD requires that a large amount of contiguous data such music and visuals be written and read quickly and therefore requires a magnetic recording disk capable of high density recording compared with typical hard disk drives for computer. In addition, positional data indicating the position of information should be recorded in order for writing and reading data quickly and accurately. Therefore, extra initial information is required to be recorded on the magnetic recording disk. The initial information is copied from a master disk.

Besides AVHDD, the inspection method according to the present invention can be applied to a high-density magnetic recording disk that requires functionality and performance comparable to AVHDD. It can be also applied to an application in which a flexible disk is used as a magnetic recording disk.

[Inspection of Mask Pattern]

The above-described inspection method for master disks can be applied to a mask pattern for manufacturing a master disk.

A mask pattern is used in forming a ferromagnetic thin-film layer on a master disk and has the same geometry as that of the ferromagnetic thin-film layer. In particular, different means and processes for forming ferromagnetic thin-film layers require different mask patterns. For example, there are mask patterns for etching, forming resists, and photolithography.

The mask pattern may have exactly the same geometry as that of the geometric pattern of a ferromagnetic thin-film layer or may slightly be different in its details from the geometric pattern of the ferromagnetic thin-film layer in consideration of a difference and deformation caused by a process and a process-specific geometry. Design data such as the above-mentioned CAD data on ferromagnetic thin-film layers is often used to design the geometry of the mask pattern.

The same substrate material as a master disk is used as the mask material of the mask pattern. It may be an inorganic material such as silicon, or a metal, ceramic, or synthetic resin. Precision processing technologies such as laser processing an photolithography are used for providing a mask pattern of the mask material.

Instead of the master disk described above, a mask material in which a mask pattern is formed is used to inspect the geometry of the mask pattern.

Marks are formed simultaneously with forming pattern geometries corresponding to ferromagnetic thin-film layers constituting an information recording section. A non-defective product manufactured previously or ferromagnetic thin-film layer design data may be used for non-defective product information. Correction may be made to ferromagnetic thin-film layer design data to generate the mask pattern non-defective product information.

Inspection of the mask pattern for manufacturing a master disk can prevent defects in the master disk which otherwise are caused by geometric defects in the mask pattern, thereby reducing a load during the inspection of the master disk.

### BRIEF DESCRIPTION OF THE DRAWINGS

FIG. 1 is a plan view of a master disk according to an embodiment of the present invention;

FIG. 2 is an enlarged view of an information recording section according to the embodiment;

FIG. 3 is a cross-sectional view of the master disk according to the embodiment;

FIG. 4 is a block diagram of an inspection apparatus according to the embodiment;

FIG. 5 shows an enlarged plan view and a cross-sectional view of a geometry of the information recording section according to the embodiment;

FIG. 6 is a schematic diagram for illustrating how CAD data is corrected according to the embodiment;

FIG. 7 is a schematic diagram for illustrating how information about a non-defective product is separately generated according to the embodiment;

FIG. 8 is a plan view of a master disk according to a prior art; and

FIG. 9 is a perspective view of a semiconductor wafer and an XY table according to the prior art.

### DESCRIPTION OF THE EMBODIMENTS

[Master disk]

A master disk 10 shown in FIGS. 1 through 3 is one used for magnetic recording media used with AVHDD.

In the master disk 10, a large number of recording bands 14 constituting an information recording section are disposed on a disc-like substrate 12 made of silicon and having a through hole in its center, as shown in FIG. 1. The master disk 10 has a nominal bore diameter of 32 mm and a nominal outer diameter of 100 mm.

The recording bands 14 radially extend in a smooth curve from the center toward outer radius and is thickened toward the outer edge. A large number of such recording bands 14 are spaced circumferentially.

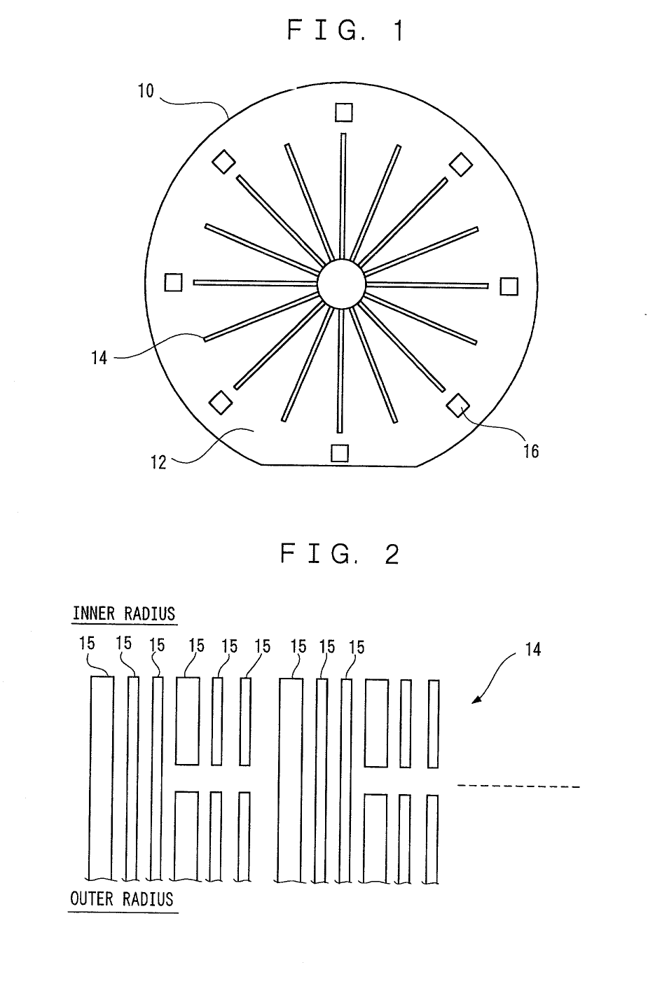

When enlarged, a plurality of thin-line ferromagnetic thin-film layers 15 are arranged or sets of ferromagnetic thin-film layers 15 are arranged in a pattern in each individual recording band 14 as shown in FIG. 2. Different numbers of ferromagnetic thin-film layers 15 of different lengths are arranged in different directions. The minimum length of the ferromagnetic thin-film layer 15 is approximately 0.3 μm. The pattern of the ferromagnetic thin-film layers 15 represents intended initial information. The outer shape of the recording band 14 in FIG. 15 indicates the outline of a set of the thin-line ferromagnetic thin-film layers 15 described above.

Specific arrangements of the ferromagnetic thin-film layers 15 constituting each recording band 14 varies, although the variation is not shown in FIG. 1.

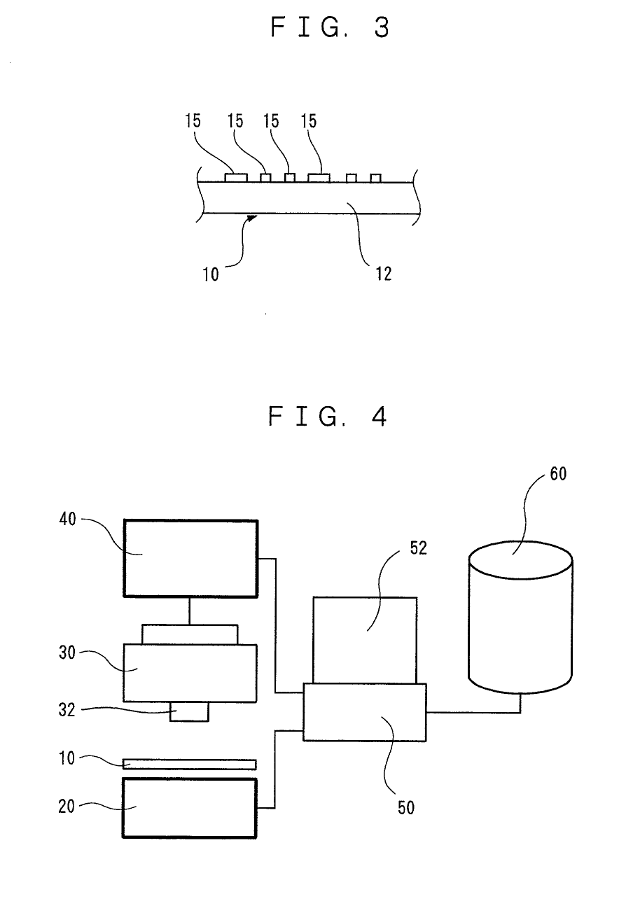

As shown in FIG. 3, the ferromagnetic thin-film layers 15 made of ferromagnetic material such as Co (cobalt) are embedded in the surface of the substrate 12. The ferromagnetic thin-film layers 15 are formed by using an appropriate thin-film deposition technology.

[Mark]

Besides the recording bands 14, which represent an information recording section, marks 16 are formed on the master disk 10 for positioning the information recording section. The marks 16 are formed as a thin-film at the same time during a thin-film deposition process for forming the ferromagnetic thin-film layers 15 constituting the recording bands 14.

Eight marks 16 are evenly spaced in short arcs on an outer circle concentric with the recording bands 14. Like the recording band 14, each mark 16 is made up of a set of thin-line ferromagnetic thin-film layers 15. The eight marks 16 have different arrangement patterns of ferromagnetic thin-film layers 15 to indicate the circumferential positions of the marks 16.

[Inspection Equipment]

Inspection equipment shown in FIG. 4 comprises an inspection stage 20 for holding a master disk 10, an image capturing module 30 for capturing the image of the master disk 10, an image processing module 40 for electronically processing the captured image, and a computer 50 for performing inspection based on an image signal.

The inspection stage 20 can be circumferentially rotated with holding the master disk 10. The rotational position of the master disk 10 is detected by an encoder (not shown) and information about the position is sent to the computer 50 to allow for synchronization with image capture operation of the image capturing module 30.

The image capturing module 30 includes an optical microscope having an image pickup lens 32 facing the surface of the mask disk 10 and converts. An electronic camera or photo-electric converter mechanism contained in the image capturing module 30 converts an enlarged image of the surface of the master disk 10 into an electronic image signal to capture the image.

The image pickup lens 32 of the image capturing module 30 is movable in the direction of the radius of the master disk 10 and, in combination with the rotation of the master disk 10, can capture enlarged image of any position on the master disk 10.

The image processing module 40 extracts information about outlines from the image information captured by the image capturing module 30 and represents a difference between a ferromagnetic thin-film layer 15 and the substrate 12 as black-and-white information or a difference in binary information, or otherwise converts the information into a signal suitable for processing by the computer 50. The image processing module 40 does not need to be a separate device if the computer 50 includes the function of the image processing module 40 or the processing unit of the computer 50 performs the function of the image processing module 40. It may be a circuit board containing image processing circuitry in the computer 50.

The computer 50 accepts and inspects the image signal captured by the image capturing module 30. The computer 50 may be a general purpose personal computer having a processing unit, storage, and input/output units. Information about a correct geometric pattern of information recording section that is used as reference for inspection, that is, non-defective-product data 60, is input and stored in the computer 50.

The non-defective-product data 60 may be image data about a product proved non-defective among master disks 10 manufactured in the past by using a certain inspection method. It may be CAD design data concerning the master disk 10.

The non-defective-product data 60 can be compared with image data about the master disk 10 to determine whether the image data about the master disk 10 matches with the non-defective-product data 60. The graphical image of the master disk 10 and the results of the inspection such as defective or non-defective can be displayed on a display 52 of the computer 50.

[Inspection Process]

A master disk 10 to be inspected is mounted on the inspection disk 20 as shown in FIG. 4.

The image of the surface of the master disk 10 on which a recording section 14 is formed is captured by the image capturing module 30, converted into electronic form through the image processing module 40, then the electronic image data is sent to the computer 50.

Before inspecting the recording section 14 using this image data, the computer 50 performs positioning.

That is, the images of marks 16 provided at a number of positions on the master disk 10 are captured by the image capturing module 30 and this information is sent to the computer 50. The computer 50 can determine from the position of each mark 16 that the center of the information recording section, that is, a plurality of recording bands 14, exists in the center of each mark 16. It also determines the position of a certain recording band 14 that is the base point of the information recording section in the circumference direction or the start point of initial information, that is, the data origin, recorded in the information recording section.

In this way, the accurate position information about the information section of the maser disk 10, then, based on this positional information, the image pickup lens 32 of the information capturing module 30 is positioned over the position of the certain recording band 14 from which the inspection is started, or the inner end or outer end of the certain recording band 14 from which the inspection is started. To do so, the master disk 10 on the inspection stage 20 may be rotated or moved radially, or the image pickup lens 32 or its supporting mechanism may be moved.

During the inspection of each recording band 14, the image data of the recording band 14 captured is compared with stored non-defective product data about a corresponding recording band 14 to determine whether the geometry of the recording band 14 is acceptable or not. One recording band 14 may be divided into plural blocks and the image of each block may be captured, the image data may be compared with non-defective product data about a corresponding block, and the comparison process may be repeated for each of the blocks to inspect the entire recording band 14.

This operation is performed for all of the plurality of recording bands 14 to complete the inspection for the entire information recording section of the master disk 10.

If the results shows that the geometries of all the recording bands 14, the master disk 10 is judged as being non-defective. The master disk 10 judged as being non-defective is used to copy initial information to a magnetic recording disk. A master disk 10 judged as being defective is discarded or transferred to a re-processing stage.

[Non-defective Product Data]

In the above-described inspection method, data about an actually captured image of a master disk 10 judged as being non-defective maybe used as the non-defective product data.

However, a certain inspection method is required for pre-determining that a particular master disk 10 is non-defective.

For example, a microscope image may be visually inspected. However, this method takes much time. In addition, variation may results from worker to worker and a defect may be overlooked.

A method may be possible in which a master disk 10 is used to copy initial information to a magnetic recording disk, then information is written on and read from the magnetic recording disk, and if no failure occurs, then the master disk 10 is judged as being non-defective. However, this method does not enable quick inspection because it does not show defective/non-defective determination of the master disk 10 until the information is written on and read from the magnetic recording disk. It is difficult to detect a defect in the master disk 10 that does not exhibit itself after one or a few write/read operations of information on the magnetic recording disk.

Either of these methods requires that a certain number of master disks 10 be manufactured and a non-defective one be selected from them, taking much time and labor to select the non-defective disk.

To solve these problems, CAD data used for designing each information recording section, that is, each recording band 14, in manufacturing the master disk 10 may be used.

[Design Data]

To form thin-line ferromagnetic thin-film layers 15 constituting each recording band 14 on a master disk 10, photo mask patterns, resist patterns, and laser scan patterns are produced based on design data generated as electronic data such as CAD data in advance. The design data include full information about the geometry of each recording band 14.

Therefore, the design data, in particular, CAD data, which is manageable and highly general, is used to obtain non-defective product data.

The CAD data can be input into the computer 50 and image data about each recording band 14 can be generated based on the information. The image data can be represented by a line drawing outlining ferromagnetic thin-film layers 15 or a set of numeric values that differentiates the presence and absence of a ferromagnetic thin-film layer 15 with binary data.

The image data thus generated can be used as non-defective product data during the inspection of a master disk 10.

The above-mentioned design data will represent the most correct geometry of the recording band 14 in theory. No human factors such as differences in skill of workers and overlooks can be introduced during the generation of the non-defective product data. Because the non-defective product data based on design data can be provided before manufacturing a master disk 10, the master disk 10 immediately after the start of the production can be inspected.

[Difference Between Captured Image and CAD Data Image]

The above-described non-defective product data derived from CAD data represents the geometry of an ideal recording band 14 or ferromagnetic thin-film layer 15. However, an inevitable difference results between the geometry of a recording band 14 and ferromagnetic thin-film layer 15 on an actually manufactured master disk 10 and designed geometry represented by CAD data. The difference can affect the accuracy of inspection.

one of causes of this difference will be described below.

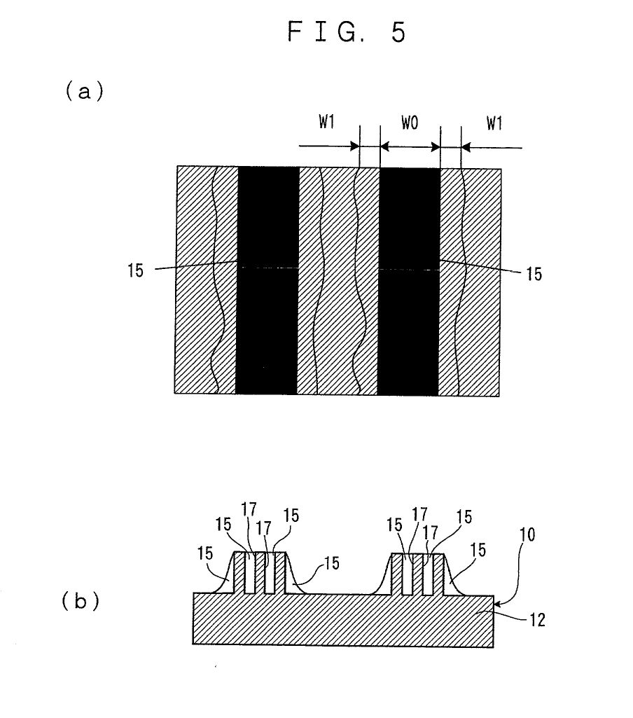

Enlarging the details of the cross-sectional structure of the master disk 10 shown in FIG. 3, ferromagnetic thin-film layers 15 made of cobalt are embedded in trenches 17 provided in a silicon substrate 12 by a process such as etching as shown in FIG. 5b. Because of manufacturing restrictions on the trench 17 or technical restrictions for ensuring the embodiment of the ferromagnetic thin-film layer 15 in the trench 17, the interior wall of the trench 17 often has a profile tapered downward. The angle of some tapers may be approximately 30 degrees.

When the ferromagnetic thin-film layer 15 having a rectangular profile is embedded in the trench having such an inverted trapeziform profile, a slight gap is produced between the sides of the ferromagnetic thin-film layer 15 and the inside walls of the trench 17.

Even if the profile of the trench 17 is made closer to a rectangular, an inappreciable gap could be produced between the trench 17 and the ferromagnetic thin-film layer 15 made of a material different from the trench.

Geometry in FIG. 5a shows the image of a ferromagnetic thin-film layer 15 having such a structure captured from above. Depending on the resolution of the image capturing means, the gap between the ferromagnetic thin-film layer 15 and the trench 17 typically cannot be clearly captured and appears as blurred intermediate regions between the surface of the ferromagnetic thin-film layer 15 and the surface of substrate 12 on both sides. The intermediate regions having width W1 exist on both sides of the ferromagnetic thin-film layer 15 having width W0.

On the other hand, the image of the ferromagnetic thin-film layer 15 from the CAD data as described above is a band both sides of which is represented by definite straight lines and has width W0 according to the design of the ferromagnetic thin-film layer 15.

If the image of the master disk 10 product shown in FIG. 5a were inspected by using the image represented by the CAD data as non-defective product data, the above-mentioned intermediate regions having width W1 would be identified as defects such as soil or contamination. If these were recognized as defects, the master disk 10 product would be judged as being defective. No acceptable master disks 10 would be provided.

To solve this problem, the sensitivity of inspection or the precision of image analysis may be lowered so that a difference between non-defective product data based on CAD data and the image of a master disk 10 product is not recognized as a defect if it is near the width, W1, of the intermediate region described above.

However, if the inspection sensitivity or image analysis precision is reduced in this way, contamination or defects smaller or thinner than width W1 cannot be detected and therefore the possibility of overlooking a defective product will increase.

[CAD Data Correction]

To eliminate the difference between non-defective product data derived from CAD data and the geometry of a master disk 10 product without reducing the sensitivity of inspection, the following method is used.

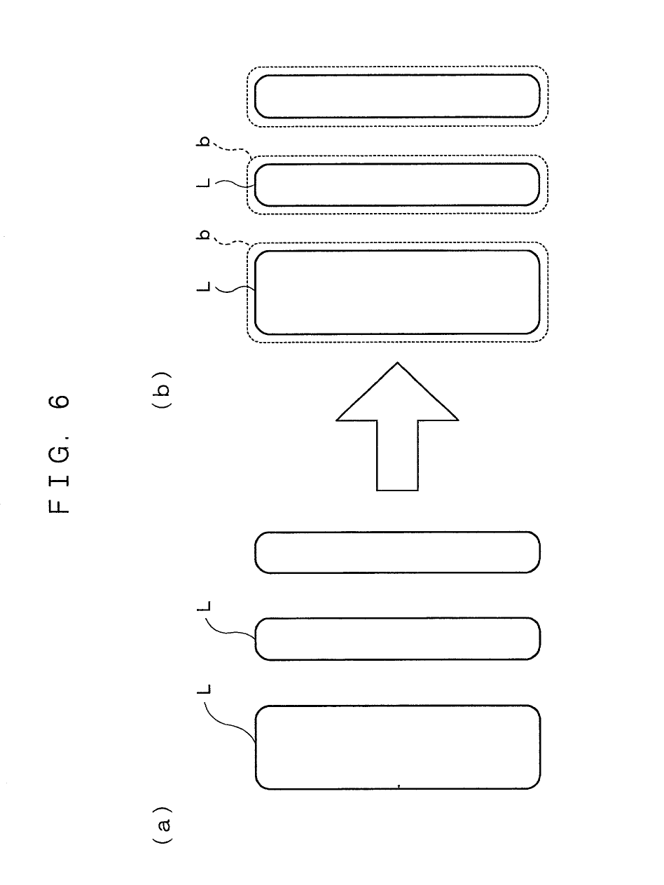

As shown in FIG. 6a, the image L of a thin-line ferromagnetic thin-film layer produced from CAD data has a definite outline.

As shown in FIG. 6b, the image L is processed electronically to add the image of a dead zone b having a predetermined width to the periphery of image L for correction.

While it has been described that image L and the image of dead zone are produced from the CAD data for visual simplicity in FIGS. 6a and 6b, it is not required that non-defective product data used in actual inspection be an image or an image itself be corrected. Instead, simply numeric calculations for correction may be applied to the CAD data.

A specific example of the correction will be described below. A position where a ferromagnetic tin-film layer exists is represented by “1” and a position where no ferromagnetic thin-film layer exists is represented by “0” in non-defective data derived from CAD data. Data on a line of the ferromagnetic thin-film layer 15 may be represented by “0001111000000”. If dead zone b is represented by “2”, corrected data to which dead zone b is added can be represented by “0021111200000”.

The CAD data corrected in this way is used as non-defective product data.

During inspection, the image data in dead zone b of a master disk 10 is not compared with the non-defective product data in the computer 50. The comparison inspection is performed only in areas other than dead zone b. Because the above-mentioned difference between the non-defective product data derived from the CAD data and the image data about the master disk 10 could arise in dead zone b, the problem of judging an acceptable product as being a defective product can be avoided by not performing the comparison in dead zone b.

Inspection sensitivity can be adequately improved in areas other than dead zone b to avoid overlooking defects.

[Block Conversion of CAD Data]

The amount of image data representing the geometries of individual ferromagnetic thin-film layers 15 in recording bands 14 all over a master disk 10 is huge. Accordingly, the amount of non-defective product data used for inspection is also huge.

To store the entire non-defective product data required for the master disk 10 in the computer 50, the capacity of a storage device should be increased.

Especially when the non-defective product data generated from CAD data is corrected as described above, even more capacity of the storage is required to store both of the uncorrected data and corrected data, which may become more impractical.

A quick and reliable inspection method without having to increase the storage capacity of the computer 50 used for the inspection will be described below.

Typical CAD data represents outlines of graphics by using vectors and therefore the amount of the data is far small compared with a representation of the graphics by using an image such as a bitmapped image. Therefore, the CAD data itself can be adequately stored in a small computer 50 such as a typical personal computer.

When a master disk 10 is inspected, non-defective product data for a recording band 14 or ferromagnetic thin-film layer 15 is generated from only a portion of CAD data that corresponds to one frame that can be captured by an image pickup lens 32 or a section of the frame. Dead zone d described above is added for correction as needed.

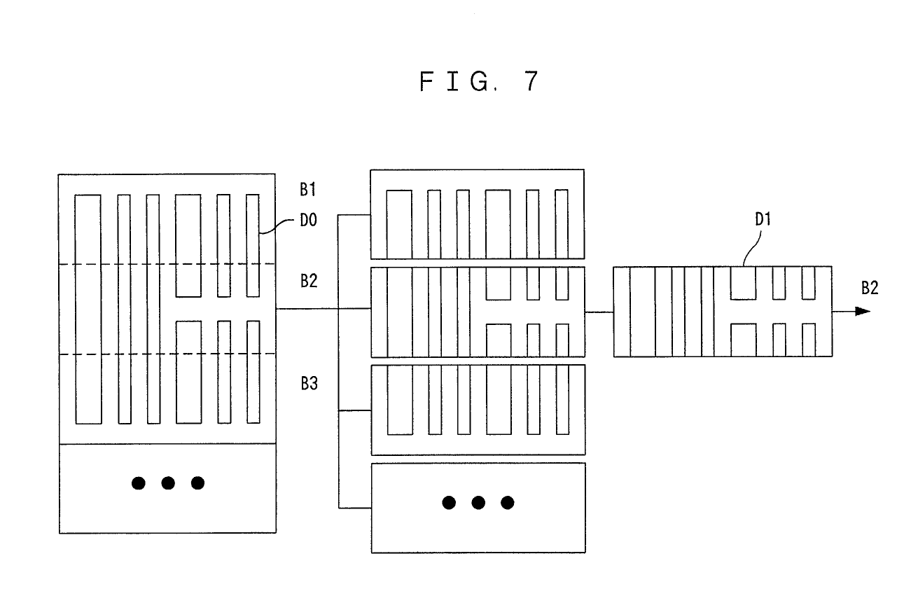

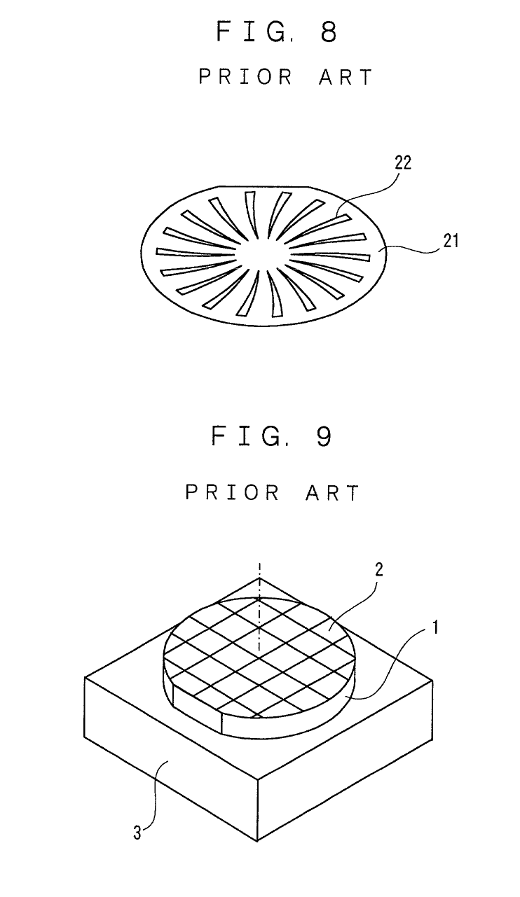

In particular, image data DO representing one recording band 14 derived from the CAD data is divided into a number of small blocks B1, B2, . . . as schematically shown in FIG. 7. Image data DO is a set of images L of thin-line ferromagnetic thin-film layers in FIG. 6a described earlier.

Adding the above-described dead zone b to data B1 on one block for correction produces corrected block Bx. Image Dx of the recording band consisting of the ferromagnetic thin-film layers that is represented by data on corrected block Bx has image L representing the outline of each ferromagnetic thin-film layer 15 that includes dead zone b, which is not shown. Corrected block Bx is non-defective product data.

Once the non-defective product data on one block is generated in this way, the non-defective product data is compared with product image data corresponding to the non-defective product data to inspect the product. This product image is the image of one block of the product obtained in a ways similar to the process described above. The image of one block of the product can be obtained by Because the amount of the non-defective product data and the product image data is relatively small, the inspection can be performed quickly.

after the inspection of the block is completed, the data on corrected block Bx generated previously is discarded and the nest data block, B2, (generated from CAD data) is taken and corrected to provided a new corrected block Bx. The corrected block Bx is used as non-defective product data to inspect product image data. This process is repeated sequentially to complete the inspection of the recording band 14.

In this method, corrected block Bx derived from only one block is used as non-defective data for inspection, only a small amount of data storage in the computer 50 is required and the inspection can be performed quickly.

[Inspection of Mask Pattern]

The master disk described above can be manufactured through the following process:

(1) A resist layer is provided on a silicon substrate forming the master disk.

(2) A mask pattern is placed on the resist layer and the resist layer is selectively removed to produce a pattern according to the mask pattern by using photolithography.

(3) Etching is performed on the resist layer to engrave the silicon substrate according to the resist layer pattern. Patterned trenches are formed in the silicon substrate.

(4) Co is spattered. A Co layer is formed in recesses in the silicon substrate and on the surface of the resist layer.

(5) The resist layer is lifted off together with the Co layer on it.

As the result of the above described process, a master disk in which a ferromagnetic thin-film layer made of Co are embedded in the recesses in the silicon substrate is produced.

As can be understood from the foregoing description of the process, the mask pattern has a shape corresponding to the geometric pattern of the ferromagnetic thin-film layer. Any defect in the mask pattern appears as a geometric defect of the ferromagnetic thin-film layer.

Therefore, the geometry of the mask pattern can also be inspected by using the equipment and process similar to those used for the master disk inspection described earlier.

Marks similar to those in the ferromagnetic thin-film layer are provided in the mask pattern.

CAD data about the ferromagnetic thin-film layer can be used as non-defective product information. However, there is no mask patterns in intermediate regions W1 of the master disk 10 shown in FIG. 5a where the outline of the ferromagnetic thin-film layer 15 is blurred. Therefore, the correction by adding dead zone b on the precondition of the presence of intermediate region W1 is not required. If there is a certain difference or error between the mask pattern and the geometry of the resist layer removed according to the mask pattern or the geometry of the recesses produced in the silicon substrate, the difference or error can be added to a mask pattern generated from CAD data to correct to the CAD-data derived mask pattern to provide non-defective product information.

Processes such as capturing the image of the mask pattern and the comparison of the captured image with the non-defective information are performed in the same way as those described with respect to the master disk.

If the mask pattern is judged as being non-defective, the mask pattern is used to manufacture the master disk. If any defect is detected in the mask pattern, the mask pattern is discarded or the geometry of the mask pattern is remedied.

Inspecting the geometry of mask pattern to ensure its correctness before manufacturing the master can reduce the causes of defects in the master disk.

In the method for inspecting a master disk for magnetic recording media according to the present invention, alignment marks are provided on a master disk, and, based on these marks, the image of an information recording section of the master disk to be inspected can be accurately aligned with non-defective information generated beforehand and information on each portion of the image can be compared with each portion of the non-defective information to inspect the information recording section of the master disk for defects.

Even if different information is recorded in the information recording section of the master disk depending on circumferential or radial positions, the image of the information recording section can be accurately compared with the non-defective product information at each position for strict inspection because the image of the information recording section can be accurately aligned with the non-defective product information.

1. An inspection method for inspecting a geometric pattern of an information recording section consisting of a ferromagnetic thin-film layer formed on a master disk from which initial information is copied to a magnetic recording medium, said method comprising:
(a) forming alignment marks in a plurality of positions on a circumference concentric with the recording section simultaneously with forming the information recording section on said master disk;
(b) providing non-defective product information representing a non-defective geometric pattern of the information recording section;
(c) capturing the image of the information recording section of said master disk and the image of said marks; and
(d) aligning the image of the information recording section with the non-defective product information with respect to the image of said marks, then comparing the image of the information recording section with the non-defective product information to inspect the geometric pattern of the information recording section.

2. The inspection method according to claim 1, wherein said step (b) provides as said non-defective product information the image of the information recording section of a master disk that is judged as being non-defective among master disks manufactured.

3. The inspection method according to claim 1, wherein said step (b) generates the non-defective product information from design data about the information recording section.

4. The inspection method according to claim 3, wherein said step (b) generates the non-defective product information by making a correction to the design data about the information recording section, said correction being entailed by a difference between the design data and the geometry of a product.

5. The inspection method according to claim 4, wherein said step (b) generates the non-defective product information by making a correction of adding a dead zone to an outline of the information recording section among said design data about the information recording section.

6. The inspection method according to claim 4 or 5, wherein after aligning the image of the information recording section with the non-defective information with respect to the image of said marks, said step (d) repeats:
(d-1) dividing the image of the information recording section to obtain a division image;
(d-2) generating the non-defective information of a corresponding part each time said division image is obtained; and
(d-3) comparing said division image with the non-defective information of the corresponding part to inspect the geometric pattern of the division image of the information recording section.

7. An inspection method for inspecting a mask pattern used in forming an information recording section consisting of a ferromagnetic thin-film layer on a master disk from which initial information is copied to a magnetic recording medium, said method comprising:
(a) forming alignment marks in a plurality of positions on a circumference concentric with the information recording section simultaneously with forming a geometric pattern serving as an information recording section in said mask pattern;
(b) providing non-defective product information representing a geometric pattern of a non-defective product geometric pattern of the information recording section;
(c) capturing an image of the information recording section of said mask pattern and an image of said marks; and
(d) aligning the image of the information recording section with the non-defective product information with respect to the image of said marks, then comparing the image of the information recording section with the non-defective product information to inspect the geometric pattern of the information recording section.
